(19) United States
(12) Patent Application Publication
(10) Pub. No.: US 2006/0068665 A1
(43) Pub. Date: Mar. 30, 2006

(54) Seamed felt for forming fiber cement articles and related methods

(76) Inventors: Heinz Pernegger, Enzersdorf (AT); Hippolit Gstrein, Gloggnitz (AT)

Correspondence Address: Laura M. Kelley;Myers Bigel Sibley & Sajovec, P.A., P.O. Box 37428, Raleigh, NC, 27627, US

(21) Appl. No.: 10/953,165

(22) Filed: Sep. 29, 2004

(51) Int. Cl. B32B 5/06; B32B 5/26; B05D 3/12; D03D 13/00

(52) U.S. Cl. 442/268; 442/270; 442/203; 442/205; 442/206; 427/179

(57) ABSTRACT

A fiber cement felt is includes a set of fine top machine direction yarns and a set of fine top cross machine direction yarns interwoven with the top machine direction yarns to form a top fabric layer. A set of coarse bottom machine direction yarns and a set of coarse bottom cross machine direction yarns are interwoven to form a bottom fabric layer. Seam loops merge with the bottom machine direction yarns and define longitudinal ends of the press felt. A batt layer overlies the top fabric layer. The fiber cement felt is positioned on a series of support rolls of a fiber cement forming machine, and then the longitudinal ends of the fiber cement felt is joined at the seam loops to form an endless belt. A fiber cement slurry is deposited on the fiber cement felt, and moisture is removed from the slurry.

### FIELD OF THE INVENTION

The present invention relates generally to fabrics, and more particularly to fabrics employed to form articles of fiber cement.

### BACKGROUND OF THE INVENTION

Fiber cement is a well-known material employed in many building components, such as siding, roofing and interior structures, and pipes, particularly for waste water transport. Fiber cement typically comprises a mixture of cement (i.e., lime, silica and alumina), clay, a thickener, inorganic fillers such as calcium carbonate, and one or more fibrous materials. In the past, asbestos was commonly included as the fibrous material (see U.S. Pat. No. 4,216,043 to Gazzard et al.); because of the well-documented problems asbestos presents, now fiber cement typically includes a natural or synthetic fiber, such as acrylic, aramid, polyvinyl alcohol, polypropylene, cellulose or cotton. Fiber cement is popular for the aforementioned applications because of its combination of strength, rigidity, impact resistance, hydrolytic stability, and low thermal expansion/contraction coefficient.

To be used in siding or roofing components, fiber cement is often formed in sheets or tubes that can be used “as is” or later cut or otherwise fashioned into a desired shape. One technique of forming fiber cement articles is known as the Hatschek process. A fiber cement forming apparatus using the Hatschek process typically includes a porous fabric belt positioned on a series of support rolls. An aqueous fiber cement slurry of the components described above is created and deposited as a thin sheet or web on the porous fabric belt. The slurry is conveyed by the fabric belt over and through a series of rollers to flatten and shape the slurry. As the slurry is conveyed, moisture contained therein drains through openings in the fabric. Moisture removal is typically augmented by the application of vacuum to the slurry through the fabric (usually via a suction box located beneath the porous fabric). After passing through a set of press rolls, the fiber cement web can be dried and cut into individual sheets, collected on a collection cylinder for subsequent unrolling and cutting into individual sheets, or collected as a series of overlying layers on a collecting cylinder that ultimately forms a fiber cement tube.

The porous fabric used to support the slurry as moisture is removed is typically woven from very coarse (between about 2500 and 3000 dtex) polyamide yarns. Most commonly, the yarns are woven in a “plain weave” pattern, although other patterns, such as twills and satins, have also been used. Once they are woven, the yarns are covered on the “sheet side” of the fabric (i.e., the side of the fabric that contacts the fiber cement slurry) with a batt layer; on some occasions, the “machine side” of the fabric (i.e., the side of the fabric that does not contact the slurry directly) is also covered with a batt layer. The batt layer assists in the retrieval, or “pick-up,” of the slurry from a vat or other container for processing. Because of the presence of the batt layer(s), the fabric is typically referred to as a fiber cement “felt.”Coarse yarns have typically been employed in fiber cement felts because of the severe conditions the felt experiences during processing. For example, fiber cement felts are typically exposed to high load conditions by the forming machine. Also, there can be significant variations in tension over the felt length on the fiber cement machine, as tension may vary from as low as 2 kilopounds/cm after the forming roll to as high as 15 kilopounds/cm over suction boxes. As a result, coarse yarns having high “tenacity” and resilience have been employed. However, because the yarns are coarse, such felts have a tendency to mark the surface of the fiber cement product formed thereon, sometimes to a sufficient degree that smoothing of the surface in a subsequent operation may be required. Further, fiber cement felts are typically prone to “blinding” (the filling of the openings in the fabric mesh with fiber cement slurry) and typically must be cleaned frequently and may be removed (depending on machine conditions such as speed and load) after as little as one week. Also, such felts tend to suffer significant “compaction” (the tendency of the felt to decrease in thickness) with use. Compaction is detrimental to operation in that, as the felt decreases in thickness, the pressure exerted on the fiber cement by the pressing rolls can change, thereby altering the surface characteristics as well as overall physical properties of the sheet. Also, some compaction may be localized, with the result that the fiber cement can have areas of different thickness. Accordingly, once felts have become compacted, they are typically replaced.

Fiber cement felts typically include one or more base fabric layers that are formed into endless belts. The base fabric layers can be “flat-woven” and permanently joined after weaving into an endless belt, or the fabric layers can be woven in endless form. The longitudinal ends of flat-woven fabrics are generally joined in order to form an endless belt. Although the ends of the flat-woven fabrics may be sewn together to form the endless belt prior to the attachment of batt fibers thereto to form the batt layer, sewing may be limited because of poor loop strength. In either case, the resulting endless belt may be difficult to install on the guide rolls of the fiber cement forming apparatus.

### SUMMARY OF THE INVENTION

According to embodiments of the present invention, methods of forming a fiber cement article are provided. A fiber cement felt is provided including a set of fine top machine direction yarns and a set of fine top cross machine direction yarns. The top cross machine direction yarns are interwoven with the top machine direction yarns to form a top fabric layer. A set of coarse bottom machine direction yarns and a set of coarse bottom cross machine direction yarns are interwoven to form a bottom fabric layer. Seam loops merge with the bottom machine direction yarns and define longitudinal ends of the press felt. A batt layer overlies the top fabric layer. The fiber cement felt is positioned on a series of support rolls of a fiber cement forming machine, then the longitudinal ends of the fiber cement felt are joined at the seam loops to form an endless belt. A fiber cement slurry is deposited on the fiber cement felt, and moisture is removed from the slurry to form a fiber cement web.

According to additional embodiments of the present invention, a fiber cement felt includes a set of fine top machine direction yarns and a set of fine top cross machine direction yarns interwoven with the top machine direction yarns to form a top fabric layer. A set of coarse bottom machine direction yarns and a set of coarse bottom cross machine direction yarns are interwoven with the bottom machine direction yarns to form a bottom fabric layer. Seam loops merge with the bottom machine direction yarns and define longitudinal ends of the press felt. The longitudinal ends are connectable at the seam loops to form an endless belt. A batt layer overlies the top fabric layer.

According to further embodiments of the present invention, methods of forming a fiber cement felt include providing an endless top fabric layer. The top fabric layer includes a set of fine top machine direction yarns and a set of fine top cross machine direction yarns that are interwoven with the top machine direction yarns. A flat bottom fabric layer is provided having a set of coarse bottom machine direction yarns, a set of coarse bottom cross machine direction yarns interwoven with the bottom machine direction yarns, and seam loops merging with the bottom machine direction yarns and defining longitudinal ends of the bottom fabric layer. The longitudinal ends of the bottom fabric layer are joined at the seam loops by a joining member (typically a pin or pintle wire) to form an endless belt. The top fabric layer and the bottom fabric layer are stacked to form an endless belt. A batt layer overlying the top fabric layer is needled. An incision is formed in batt layer and the top fabric layer adjacent the seam loops, and the joining member is removed so that the felt can take a flat (i.e., non-endless form).

### BRIEF DESCRIPTION OF THE FIGURES

FIG. 1 is a schematic illustration of a fiber cement forming apparatus of the present invention.

FIGS. 2 and 3 are enlarged, partial, cutaway perspective views of a fiber cement felt according to embodiments of the present invention, with FIG. 2 showing the pin seam assembled and FIG. 3 showing the pin seam unassembled.

FIG. 4 is a cross-sectional view taken along lines 4-4 of the fiber cement felt of FIG. 2 showing the seam area of the felt.

FIG. 5 is a schematic representation of a process for constructing the press felt of FIG. 1.

FIG. 6 is an enlarged, partial, cutaway perspective views of a fiber cement felt according to further embodiments of the present invention.

FIG. 7 is a cross-sectional view taken along lines 7-7 of the fiber cement felt of FIG. 6.

### DETAILED DESCRIPTION OF EMBODIMENTS OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

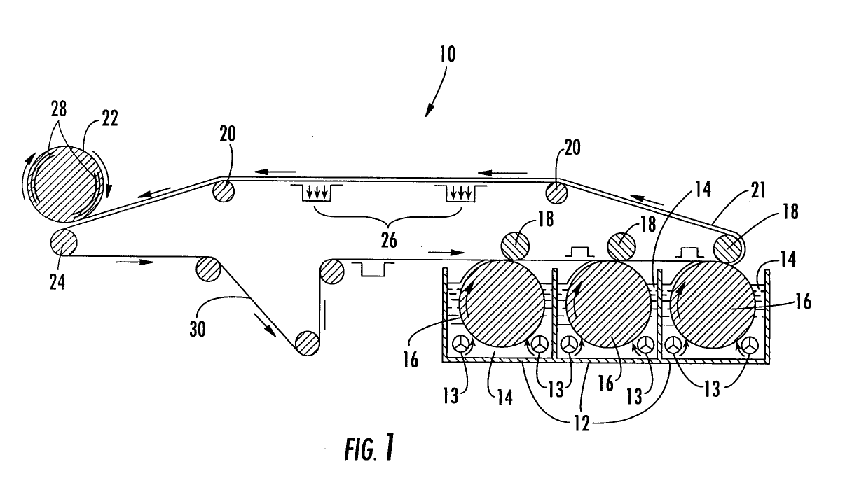

Referring now to FIG. 1, a fiber cement forming apparatus, designated broadly at 10, is illustrated therein. The forming apparatus 10, which performs a typical Hatschek process, generally includes an endless fiber cement felt 30 positioned in rolling contact with and driven by a number of guide rolls 20. Beginning in the lower right corner of FIG. 1, the felt 30 passes above three vats 12, each of which contains a batch of fiber cement slurry 14. As used herein, “fiber cement” means any cementitious composition including cement, silica, and fiber for reinforcement, including asbestos, polyvinyl alcohol, polypropylene, cotton, wood or other cellulosic material, acrylic, and aramid. It is contemplated that other materials such as thickeners, clays, pigments, and the like, that impart desirable processing or performance characteristics to the fiber cement slurry 14 or an article formed therefrom may also be included. Each vat 12 is positioned below a deposition cylinder 16 mated with a couch roll 18. Each vat 12 also includes agitators 13, which prevent the fiber cement slurry 14 from solidifying therein.

Rotation of each deposition cylinder 16 collects fiber cement slurry 14 on the cylinder's surface; as the felt 30 travels over and contacts the cylinder 16, the slurry 14 is transferred from the cylinder 16 to the felt 30. The amount of slurry 14 deposited on the fabric 30 by each cylinder 16 is controlled by the corresponding couch roll 18. Typically, the fiber cement slurry 14 is deposited as a web 21 at a thickness of between about 0.3 mm and 3 mm.

Still referring to FIG. 1, once the fiber cement slurry web 21 has been collected on the felt 30 from each of the vats 12, the felt 30 conveys the slurry web 21 over one guide roll 20, then over one or more suction boxes 26 (two are shown in FIG. 1), each of which applies negative pressure to the felt 30, thereby encouraging the removal of moisture from the slurry web 21. Finally, the felt 30 and the slurry web 21 pass over a second guide roll 20, then between the nip formed by a breast roll 24 and a forming roll 22. After passing through the nip, the slurry web 21 has formed into a semi-solid fiber cement sheet 28 that is collected on the surface of the forming roll 22.

Those skilled in this art will recognize that other forming apparatus are also suitable for use with the fiber cement felts of the present invention. For example, felts of the present invention can also be used to form fiber cement pipes. In such an operation, the fiber cement sheet 28 can be collected in contacting layers on a forming roll; as they dry, the overlying layers form a unitary laminated tube. Often, a pipe forming apparatus will include small couch rolls that act in concert with the forming roll to improve interlaminar strength. Also, a second felt may travel over the additional couch rolls to assist in water absorption and finishing.

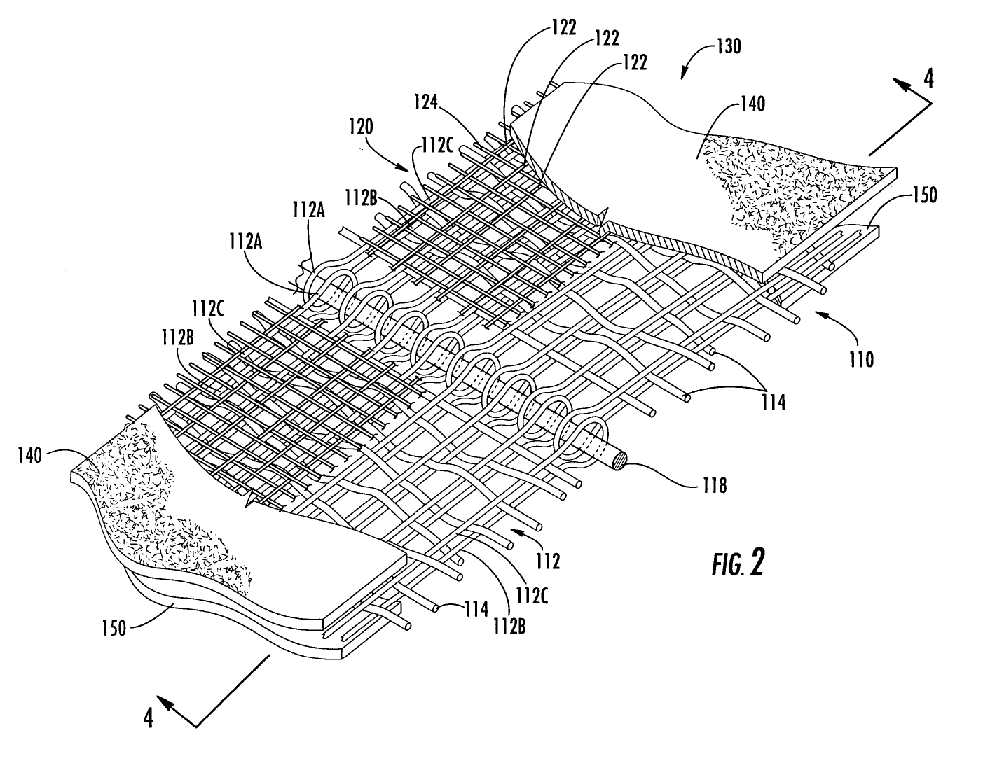

Various configurations of the felt 30 can be understood by reference to FIGS. 2-4 and 6-7. To clarify, as used herein the term “machine direction” refers to the direction the felt 30 travels on the fiber cement apparatus 10, and the term “cross machine direction” refers to the direction perpendicular to the machine direction and parallel to the plane defined by the felt 30. Within the felt 30, the terms “top”, “upper” and derivatives thereof refer to the portion of the felt 30 that faces the fiber cement stock (i.e., toward the sheet side of the felt 30), and the terms “bottom”, “lower” and derivatives thereof refer to the portion of the felt 30 that faces the machine components of the fiber cement forming apparatus 10 (i.e., toward the machine side of the felt 30). The term “duplex” refers to a fabric that has two sets of machine direction yarns at different elevations within the fabric interwoven with a single set of cross machine direction yarns.

As illustrated in FIGS. 2-4, a felt 130 includes a double layer base fabric having a bottom layer fabric 110 and a top layer fabric 120. The bottom layer fabric 110 and the top layer fabric 120 are separate and distinct fabric layers. The felt 130 also includes a top batt layer 140 that overlies the top fabric layer fabric 120 and a bottom batt layer 150 that underlies the bottom fabric layer fabric 110.

The bottom layer fabric 110 is a duplex fabric that includes bottom machine direction yarns 112 and bottom cross machine direction yarns 114. The bottom machine direction yarns 112 include seam loops 112A that merge with the bottom machine direction yarns 112 and define the longitudinal ends of the press felt 130. The bottom machine direction yarns 112 include a lower portion 112B and an upper portion 112C and are interwoven with the bottom cross machine direction yarns 114 such that the bottom cross machine direction yarns 114 pass over the upper portion 112C of one bottom machine direction yarn 112, between the upper portion 112C and lower portion 112B of the next adjacent bottom machine direction yarn 112, under the lower portion 112B of the next adjacent bottom machine direction yarn 112, and between the upper and lower portions 112C, 112B of the next adjacent bottom machine direction yarns before repeating the same sequence again.

The bottom machine direction yarns 112 and the bottom cross machine direction yarns 114 may be twists of multifilament and spun yarns and are generally coarse yarns. Coarse yarns are typically used to withstand the stresses to the fabric during processing. For example, the bottom cross machine direction yarns 114 may range in coarseness from about 50 or 80 tex to about 1500 or 3000 tex. The bottom machine direction yarns 112 may range in coarseness from about 500, 1000 or 2000 tex to about 4000 tex. As used herein, “tex” refers to the well-known unit of fineness used to describe textile yarns, in which the number of “tex” is equal to the mass in grams of a 1000 meter length of yarn.

The materials comprising yarns employed in the fabric of the present invention may be those commonly used in papermakers' fabric. For example, the yarns 112, 114 maybe formed of cotton, wool, polypropylene, polyester, aramid, polyamide, or the like, with polyamide yarns being preferred for both the machine direction yarns 122 and the cross machine direction yarns 124. Of course, the skilled artisan should select yarn materials according to the parameters of the fiber cement forming process. Those skilled in this art will recognize that other fabric patterns may be used for the bottom layer 110, such as a plain weave, a 1×2, 1×3, or 1×4 twill, a satin, or other weave pattern known to those skilled in this art.

The top fabric layer 120 is illustratively a fabric having interlaced machine direction yarns 122 and cross machine direction yarns 124. The machine direction yarns 122 interweave in an “over 2/under 2” pattern with the cross machine direction yarns 124. The yarns comprising the top layer 120 are fine yarns which can reduce the tendency of the felt 130 to cause marking on the fiber cement sheet formed thereon (such as sheet 28 in FIG. 1). Reduced sheet marking can result from processing with a finely woven mesh because the close proximity of the fine yarns to one another can support both ends of fibers within the fiber cement rather than allowing one end of a fiber to reside with the gap between yarns, as can happen with a coarser mesh. The top machine direction yarns 122 can range in diameter from about 0.2 mm to about 1.0 mm. Also, the top cross machine direction yarns 124 can have a diameter of about 0.2 to about 1.0 mm. Those skilled in this art will recognize that fabric patterns may be used for the top layer 120, such as a plain weave, a 1×2, 1×3, or 1×4 twill, a satin, or other weave pattern known to those skilled in this art.

The form of the yarns utilized in the top fabric layer 120 can vary, depending upon the desired properties of the felt 130. For example, the yarns may be multifilament yarns, monofilament yarns, twisted multifilament or monofilament yarns, spun yarns, core-wrapped yarns, or any twists or other combination thereof. It is preferred that the machine direction yarns 122 and the cross machine direction yarns 124 be monofilaments and twisted yarns.

Also, the materials comprising yarns employed in the fabric of the present invention may be those commonly used in papermakers' fabric. For example, the yarns 122, 124 may be formed of cotton, wool, polypropylene, polyester, aramid, polyamide, or the like, with polyamide yarns being preferred for both the top machine direction yarns 122 and the top cross machine direction yarns 124. Of course, the skilled artisan may select yarn materials according to the parameters of the fiber cement forming process.

The batt layers 140, 150 may be formed of material, such as a synthetic fiber like acrylic aramid, polyester, or polyamide, or a natural fiber such as wool, that assists in taking up fiber cement slurry 14 from the vats 12 to form the fiber cement web 21 in FIG. 1. Preferred materials include polyamide, polyester and blends thereof. The weight of the batt layers 140, 150 can vary, although it is preferable that the ratio of fabric weight to batt weight is about between about 1.0 and 2.0 with 1.5 being more preferred. Also, in some embodiments, it may be desirable to omit the bottom batt layer 150.

The bottom layer fabric 110 and the top layer fabric 120 are typically attached to one another to prevent relative lateral movement therebetween. For example, needling may be used to attach at least one of the batt layers 140, 150, and such needling can also be used to join the top and bottom fabric layers 120, 110.

With continued reference to FIGS. 2-4, the felt 130 includes a pin 118 that is positioned through the loops 112A of the bottom fabric layer 110 to provide a seam 162. The bottom layer fabric 110 can be woven either in flat form with the seam loops 112A interwoven with the cross machine direction yarns 114 adjacent the ends of the bottom layer fabric 110, or, alternatively, the bottom layer fabric 110 can be woven in endless form such that the loops 112A and the pin 118 or other joining member (such as a pintle wire) are woven in concert with the bottom layer fabric 110. Such weaving techniques are known to those skilled in the weaving arts and need not be described in detail herein.

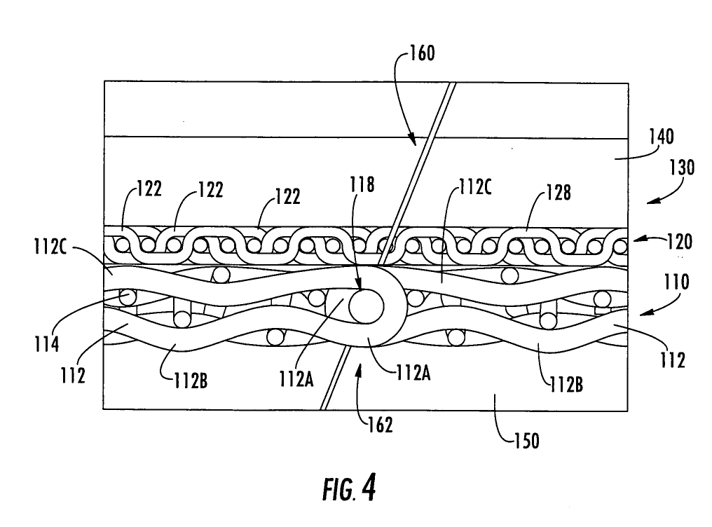

As shown in FIG. 4, the batt layers 140, 150 and the top layer fabric 120 include an incision 160 adjacent the seam 162. The incision 160 may extend at an oblique angle to the surface of the felt 130 as shown, or the incision 160 may extend along a line that is perpendicular to the felt 130.

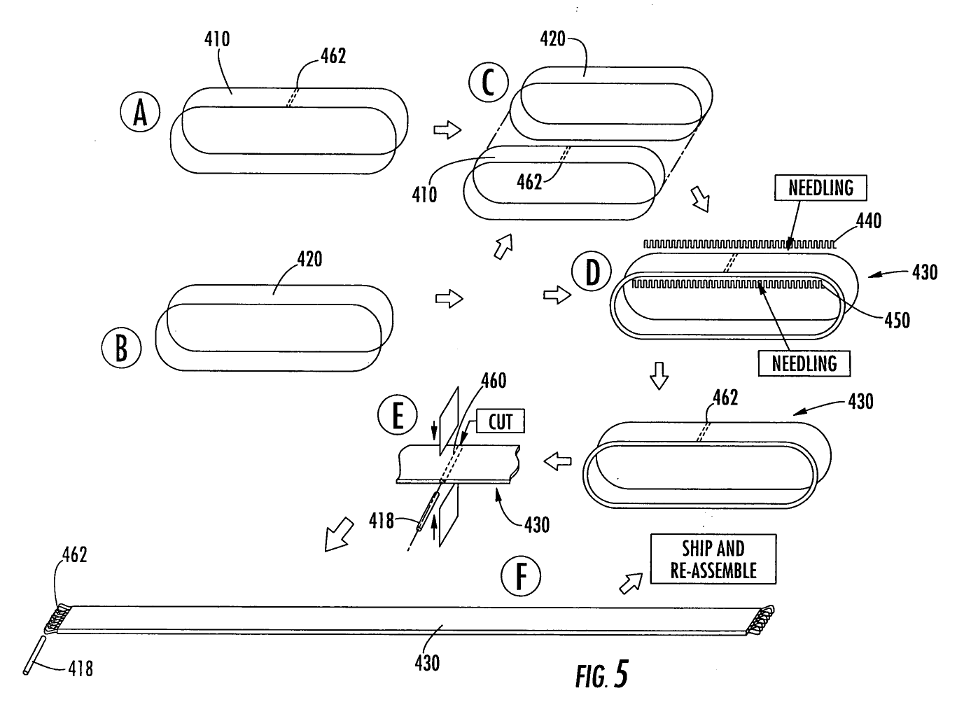

FIG. 5 illustrates an exemplary manufacturing process for felts according to embodiments of the present invention. Initially, a bottom layer fabric 410 is flat woven such that machine direction loops are created on its ends, such as is shown with loops 112A in FIGS. 2-4. A pin 418 (which is typically smaller than the pins used as the fabric is woven) is inserted through the loops 112A as they are interdigitated to join them at a seam 462 such that the bottom layer fabric 410 is formed as an endless belt (Step A). Separately, an upper layer fabric 420 is woven in a continuous belt (Step B). The top layer fabric 420 can be flat woven and formed into an endless belt using techniques known to those of skill in the art, such as by stitching the ends together or with a heat welding process, for example, employing heat or ultrasonic radiation. Alternatively, the upper layer fabric 420 can be woven in endless fashion.

The top layer fabric 420 is then positioned to overlie the bottom layer fabric 410 (Step C). The machine side and the cement fiber side batt layers 440, 450 are needled or otherwise attached to the top layer fabric 420 and the bottom layer fabric 410, respectively (Step D) to provide the felt 430.

The seam incision 460 is formed with blades or other cutting devices through the machine side and paper side batt layers 440, 450 and the top layer fabric 420, and the pin 418 is removed (Step E). An optional heat-setting step may be performed after cutting.

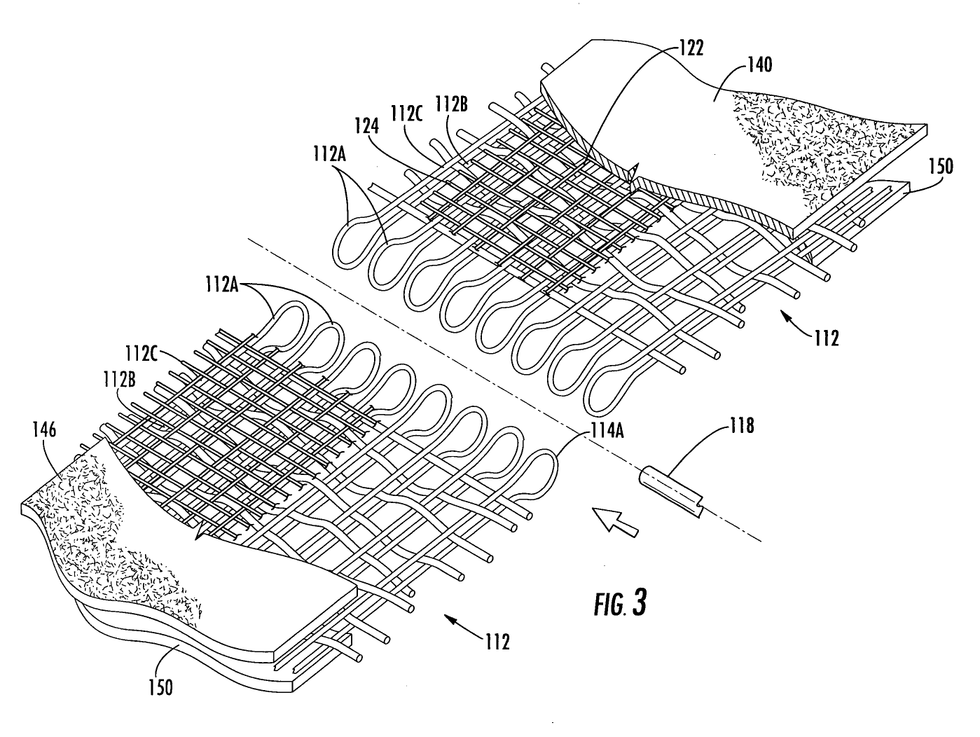

With reference to FIGS. 2-4, once the batt layers 140, 150 and the fabric 120 are cut and the pin 118 is removed, the felt 130 may be opened into flat form, shipped and installed in the fiber cement forming apparatus 10 shown in FIG. 1. On installation, the loops 112A at the ends of the felt 130 may be brought into interdigitating relation (see FIG. 3) and the pin 118 can be reinserted into the position shown in FIGS. 2 and 4. The batt layers 140, 150 and the top layer fabric 120 may be brought into abutting contiguous relation to provide a substantially uniform outer layer across the pin seam joint formed by the loops 112A; preferably, the seam 162 provides a uniform outer surface. In this configuration, the time and labor of installation on the cement forming apparatus 10 of FIG. 1 may be reduced.

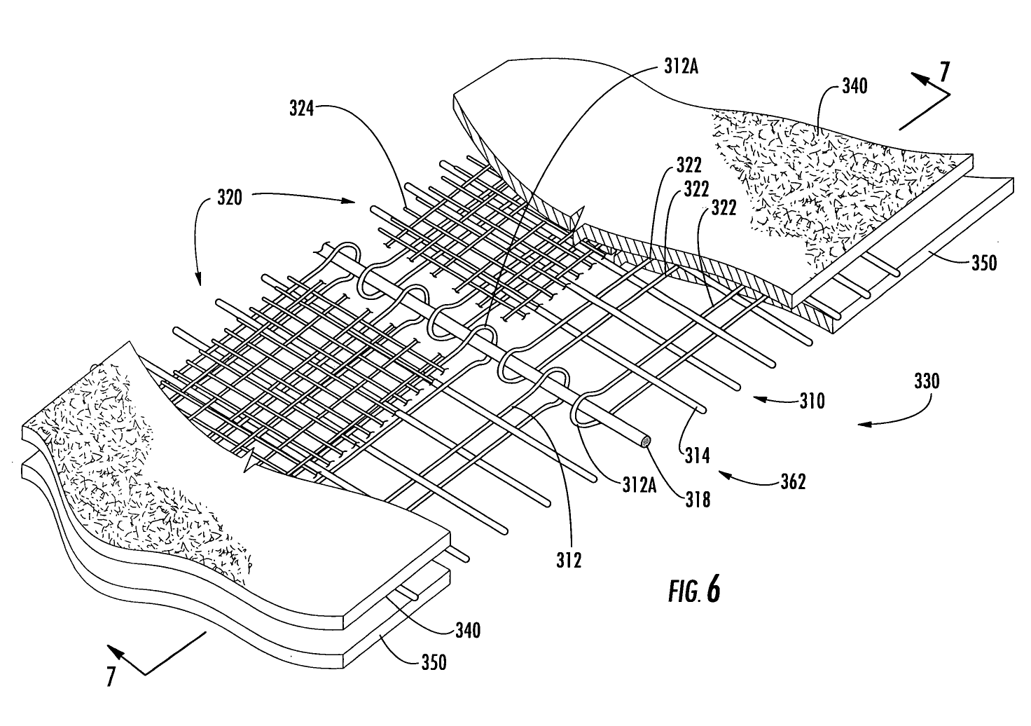

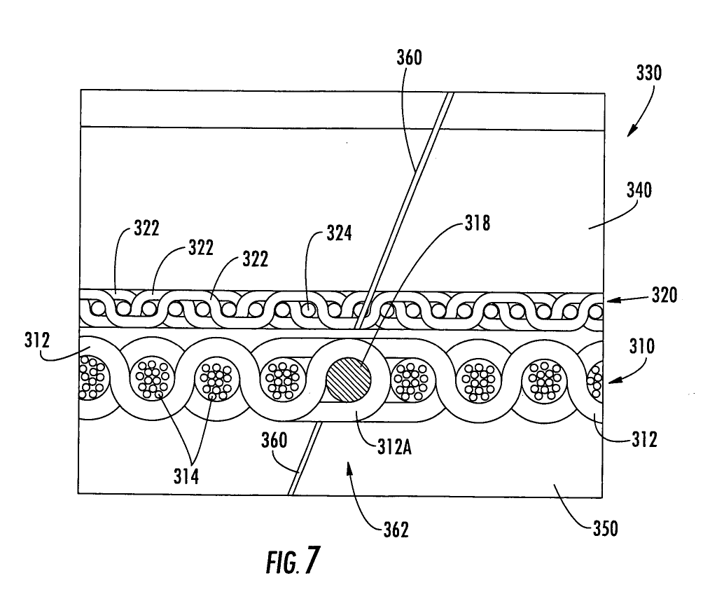

Various weave patterns may be used for top fabric layers and the bottom fabric layers to provide the seam loops according to embodiments of the present invention. For example, as illustrated in FIGS. 6-7, a felt 330 is shown that includes a bottom layer fabric 310 that includes bottom machine direction yarns 312 that interweave with bottom cross machine direction yarns 314 in a plain weave or “over 1/under 1” pattern. The bottom machine direction yarns 312 form loops 312A. The portions of the bottom machine direction yarns 312 that are opposite the loops 312A pass over one of the bottom cross machine direction yarns 314 and under the next adjacent bottom cross machine direction yarn 314 in the “over 1/under 1” pattern. The felt 330 also includes a top layer fabric 320 having top machine direction yarns 322 and top cross machine direction yarns 324 in an “over 2/under 2” pattern that is the same as the top layer fabric 220 described with respect to FIGS. 2-4, although it should be understood that other weave patterns may be used.

With reference to FIGS. 6-7, the loops 312A are formed around a removable pin 318 to provide a seam 362. The felt 330 includes a top batt layer 340 and a bottom batt layer 350. The batt layers 340, 350 and the top layer fabric 320 may be cut along line 360 and the pin 318 can be removed so that the felt 330 can be in flat form and reattached as a continuous belt by reinsertion of the pin 318, as described with respect to FIGS. 2-4.

The bottom layer fabric 310 can be woven either in flat form with the seam loops 312A interwoven with the cross machine direction yarns 314 adjacent the ends of the bottom layer fabric 310, or alternatively, the bottom layer fabric 310 can be woven in endless form such that the loops 312A and the pin 318 are integrally formed with the bottom layer fabric 310.

Both the top and bottom fabric layers 320, 310 are illustrated as “single layer” fabrics, i.e., they include single sets of machine direction yarns and cross machine direction yarns. However, it is contemplated for the present invention that various types of fabric layers can be used for either or both of the top and bottom fabric layers 320, 310. For example, the top and/or bottom fabric layers 320, 310 may be “double layer” fabrics (i.e., they may include top and bottom sets of machine direction yarns interwoven and bound with a set of cross machine direction yarns) or “triple layer” fabrics (i.e., they have top and bottom sets of interwoven machine direction yarns and cross machine direction yarns). Duplex layers (such as the bottom fabric layer 110 in FIGS. 2-4) may also be used for either the top fabric layer or the bottom fabric layer 320, 310. As another example, the top fabric layer 320 may be a spirally wound fabric, for example, as described in U.S. Pat. Nos. 5,360,656; 6,124,015 and 6,723,208, the disclosures of which are hereby incorporated by reference in their entireties; such spirally wound fabrics may be woven or non-woven, or may even simply comprise yarn arrays.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. The invention is defined by the following claims, with equivalents of the claims to be included therein.

That which is claimed is:

1. A method of forming a fiber cement article, comprising the steps of:
(a) providing a fiber cement felt, the fiber cement felt comprising:
a set of fine top machine direction yarns;
a set of fine top cross machine direction yarns interwoven with the top machine direction yarns to form a top fabric layer;
a set of coarse bottom machine direction yarns;
a set of coarse bottom cross machine direction yarns interwoven with the bottom machine direction yarns to form a bottom fabric layer;
seam loops merging with the bottom machine direction yarns and defining longitudinal ends of the press felt; and
a batt layer overlying the top fabric layer
(b) positioning the fiber cement felt on a series of support rolls of a fiber cement forming machine; then
(c) joining the longitudinal ends of the fiber cement felt at the seam loops to form an endless belt;
(d) depositing a fiber cement slurry on the fiber cement felt; and
(e) removing moisture from the slurry to form a fiber cement web.

2. The method of claim 1, wherein the bottom cross machine direction yarns are between about 50 tex and about 3000 tex.

3. The method of claim 1, wherein the bottom cross machine direction yarns are between about 80 and about 1500 tex.

4. The method of claim 1, wherein the bottom machine direction yarns are between about 500 and about 4000 tex.

5. The method of claim 1, wherein the bottom machine direction yarns are between about 1000 and about 4000 tex.

6. The method of claim 1, wherein the bottom machine direction yarns include upper and lower portions, each of which interweave with the bottom cross machine direction yarns, and wherein the upper portions and lower portions of the bottom machine yarns merge with the seam loops.

7. The method of claim 1, wherein the bottom machine direction yarns and the bottom cross machine direction yarns interweave in a plain weave pattern.

8. The method of claim 1, further comprising a batt layer attached to and underlying the bottom machine direction yarns.

9. The method of claim 1, wherein the top cross machine direction yarns and top machine direction yarns are selected from the group consisting of: single monofilaments and monofilament twists.

10. The method of claim 1, wherein the top cross machine direction yarns and top machine direction yarns have a diameter of about 0.2 mm to about 1.0 mm.

11. The method of claim 1, wherein the top cross machine direction yarns interweave with the top machine direction yarns in a series of repeat units in which each top machine direction yarn passes over two adjacent machine direction yarns and under the next two adjacent machine direction yarns.

12. The method of claim 1, wherein the joining step comprises inserting a pintle wire in the seam loops to join the longitudinal ends of the fiber cement felt.

13. A fiber cement felt, comprising:
a set of fine top machine direction yarns;
a set of fine top cross machine direction yarns interwoven with the top machine direction yarns to form a top fabric layer;
a set of coarse bottom machine direction yarns;
a set of coarse bottom cross machine direction yarns interwoven with the bottom machine direction yarns to form a bottom fabric layer;
seam loops merging with the bottom machine direction yarns and defining longitudinal ends of the press felt, the longitudinal ends being connectable at the seam loops to form an endless belt; and
a batt layer overlying the top fabric layer.

14. The fiber cement felt of claim 13, wherein the bottom cross machine direction yarns are between about 50 tex and about 3000 tex.

15. The fiber cement felt of claim 13, wherein the bottom cross machine direction yarns are between about 80 and about 1500 tex.

16. The fiber cement felt of claim 13, wherein the bottom machine direction yarns are between about 500 and about 4000 tex.

17. The fiber cement felt of claim 13, wherein the bottom machine direction yarns are between about 1000 and about 4000 tex.

18. The fiber cement felt of claim 13, wherein the bottom machine direction yarns include upper and lower portions, each of which interweave with the bottom cross machine direction yarns, and wherein the upper portions and lower portions of the bottom machine yarns merge with the seam loops.

19. The fiber cement felt of claim 13, wherein the bottom machine direction yarns and the bottom cross machine direction yarns interweave in a plain weave pattern.

20. The fiber cement felt of claim 13, further comprising a batt layer attached to and underlying the bottom machine direction yarns.

21. The fiber cement felt of claim 13, wherein the top cross machine direction yarns and top machine direction yarns are selected from the group consisting of: single monofilaments and monofilament twists.

22. The fiber cement felt of claim 13, wherein the top cross machine direction yarns and top machine direction yarns have a diameter of about 0.2 mm to about 1.0 mm.

23. The fiber cement felt of claim 13, wherein the top cross machine direction yarns interweave with the top machine direction yarns in a series of repeat units in which each top machine direction yarn passes over two adjacent machine direction yarns and under the next two adjacent machine direction yarns.

24. The fiber cement felt of claim 13, further comprising a pintle wire inserted in the seam loops to join the longitudinal ends of the fiber cement felt.

25. A method of forming a fiber cement felt, the method comprising:
providing an endless top fabric layer, the top fabric layer comprising a set of fine top machine direction yarns and a set of fine top cross machine direction yarns interwoven with the top machine direction yarns;
providing a flat bottom fabric layer, the bottom fabric layer comprising a set of coarse bottom machine direction yarns, a set of coarse bottom cross machine direction yarns interwoven with the bottom machine direction yarns, and seam loops merging with the bottom machine direction yarns and defining longitudinal ends of the bottom fabric layer;
joining the longitudinal ends of the bottom fabric layer at the seam loops to form an endless belt;
stacking the top fabric layer and the bottom fabric layer to form an endless belt;
needling a batt layer overlying the top fabric layer; and
forming an incision in the batt layer and the top fabric layer adjacent the seam loops.

26. The method of claim 25, wherein the joining step comprises:
positioning a pin through the seam loops to join the longitudinal ends of the bottom fabric layer; and wherein the method further comprises:
removing the pin to provide a flat fiber cement felt.

27. A fiber cement felt, comprising:
a top fabric layer;
a set of coarse bottom machine direction yarns;
a set of coarse bottom cross machine direction yarns interwoven with the bottom machine direction yarns to form a bottom fabric layer;
seam loops merging with the bottom machine direction yarns and defining longitudinal ends of the press felt, the longitudinal ends being connectable at the seam loops to form an endless belt; and
a batt layer overlying the top fabric layer.

28. The fiber cement felt of claim 27, wherein the bottom cross machine direction yarns are between about 50 tex and about 3000 tex.

29. The fiber cement felt of claim 27, wherein the bottom cross machine direction yarns are between about 80 and about 1500 tex.

30. The fiber cement felt of claim 27, wherein the bottom machine direction yarns are between about 500 and about 4000 tex.

31. The fiber cement felt of claim 27, wherein the bottom machine direction yarns are between about 1000 and about 4000 tex.

32. The fiber cement felt of claim 27, wherein the bottom machine direction yarns include upper and lower portions, each of which interweave with the bottom cross machine direction yarns, and wherein the upper portions and lower portions of the bottom machine yarns merge with the seam loops.

33. The fiber cement felt of claim 27, wherein the bottom machine direction yarns and the bottom cross machine direction yarns interweave in a plain weave pattern.

34. The fiber cement felt of claim 27, further comprising a batt layer attached to and underlying the bottom machine direction yarns.

35. The fiber cement felt of claim 27, further comprising a pintle wire inserted in the seam loops to join the longitudinal ends of the fiber cement felt.

36. The fiber cement felt of claim 27, wherein the top fabric layer comprises a spirally wound fabric.
